(19) United States
(12) Patent Application Publication
(10) Pub. No.: US 2024/0051638 A1
(43) Pub. Date: Feb. 15, 2024

(54) BICYCLE AUTOMATIC SHOCK ABSORBING DEVICE

(71) Applicant: Ming-Ta Tsai, NEW TAIPEI CITY (TW)

(72) Inventor: Ming-Ta Tsai, NEW TAIPEI CITY (TW)

(21) Appl. No.: 17/883,637

(22) Filed: Aug. 9, 2022

(51) Int. Cl. B62K 25/08; H01M 50/249; H01M 50/242; H01M 10/46

(52) U.S. Cl. CPC B62K 25/08; H01M 50/249; H01M 50/242; H01M 10/46; B62K 2025/044

(57) ABSTRACT

A bicycle automatic shock absorbing device is provided. The bicycle automatic shock absorbing device includes a shock absorbing battery, a control chip, a sensor, and a driving module installed on a shock absorber. In operation, the control chip executes the automatic shock absorbing mode. The sensor detects shock impact and transmits a detection signal to the control chip. The control chip transmits an adjustment signal to the driving module, so that the driving module changes the damping response of the shock absorber. The control chip can determine and change the damping effect of the shock absorber to adapt to the road conditions while riding, so as to automatically adjust the damping of the shock absorber according to the road conditions.

### FIELD OF THE DISCLOSURE

The present disclosure relates to a bicycle shock absorbing device, and more particularly to a shock absorbing device that can automatically change the damping effect according to the road conditions.

### BACKGROUND OF THE DISCLOSURE

Shock absorbers used in bicycles, the front fork shock absorbers as disclosed in TWM602994, TWM536300, CN209067742U, TWI413601, U.S. Ser. No. 10/668,975B2 and U.S. Ser. No. 10/337,584B2 show the several types of front fork shock absorbers with individually or in a combination of air pressure, oil pressure, and/or spring, etc.

The damping effect of the above shock absorbers is adjusted according to the rider, the type of bicycle (such as single shock absorber or double shock absorbers), and the road conditions (country roads, industrial roads, or forest roads). It is trouble to operate, and even requires additional tools for adjustment. Accordingly, it is not simple and easy to adjust for ordinary cyclists. During non-competition, cyclists do not frequently adjust the fine-tuning of the front fork damping, so that the shock absorber with adjustment function or the above-mentioned patented products are not able to perform at its maximum effectiveness.

### SUMMARY OF THE DISCLOSURE

The present disclosure is a bicycle automatic shock absorbing device, which includes a shock absorbing battery, a control chip, a sensor, and a driving module installed in a shock absorber; wherein the shock absorbing battery is electrically connected to the control chip, the sensor and the driving module correspondingly; wherein the control chip signally connected to the sensor and the driving module correspondingly. Further, when the control chip operates an automatic shock absorbing mode, the sensor detects the shock impact and transmits a signal to the control chip, and the control chip transmits an adjustment signal to the driving module, so that the driving module changes the damping response of the shock absorber.

For example, the above-mentioned shock absorber refers to the front fork of a bicycle.

When the bicycle automatic shock absorbing device of the present disclosure operates, the control chip executes the automatic shock absorbing mode, the shock impact during riding is detected through the sensor and transmitted a detection signal to the control chip, and the control chip transmits the adjustment signal to the driving module, so that the driving module changes the damping response of the shock absorber instantly. Therefore, the condition can be detected by the sensor and transmitted to the control chip while riding, and the control chip determines the riding process and transmits the control signal to the driving module to instantly change the damping effect of the shock absorber and meet the road conditions. Accordingly, the damping response performance of the shock absorber can be automatically adjusted according to the road conditions.

### BRIEF DESCRIPTION OF THE DRAWINGS

The described embodiments may be better understood by reference to the following description and the accompanying drawings in which:

FIG. 1 is a block schematic diagram of the present disclosure.

FIG. 2 is a schematic perspective view of the bicycle automatic shock absorbing device of the present disclosure applied to bicycle front fork.

FIG. 3 is a sectional schematic view of FIG. 2, in which the front fork is locked.

FIG. 4 is a partial enlarged schematic view of A in FIG. 3.

FIG. 5 is a partial enlarged schematic view of B in FIG. 3, wherein the end of the stem closes the flow channel (the hard shock absorbing mode).

FIG. 6 is a schematic view of the end of the stem near the flow channel (the balanced shock absorbing mode).

FIG. 7 is a schematic view of the end of the valve stem away from the flow channel (the soft shock absorbing mode).

FIG. 8 is a schematic view of the control chip including an automatic shock absorbing mode, a soft shock absorbing mode, a balanced shock absorbing mode, and a hard shock absorbing mode.

FIG. 9 is a schematic view of changing the damping effect of the shock absorber when the acceleration changes in the automatic shock absorbing mode of the present disclosure.

FIG. 10 is a schematic view of the fixed controller and the portable device mounted on the bicycle.

FIG. 11 is a schematic view of the fixed controller operating to switch the shock absorbing mode.

FIG. 12 is a schematic view of the operation interface of the portable device.

### DETAILED DESCRIPTION OF THE EXEMPLARY EMBODIMENTS

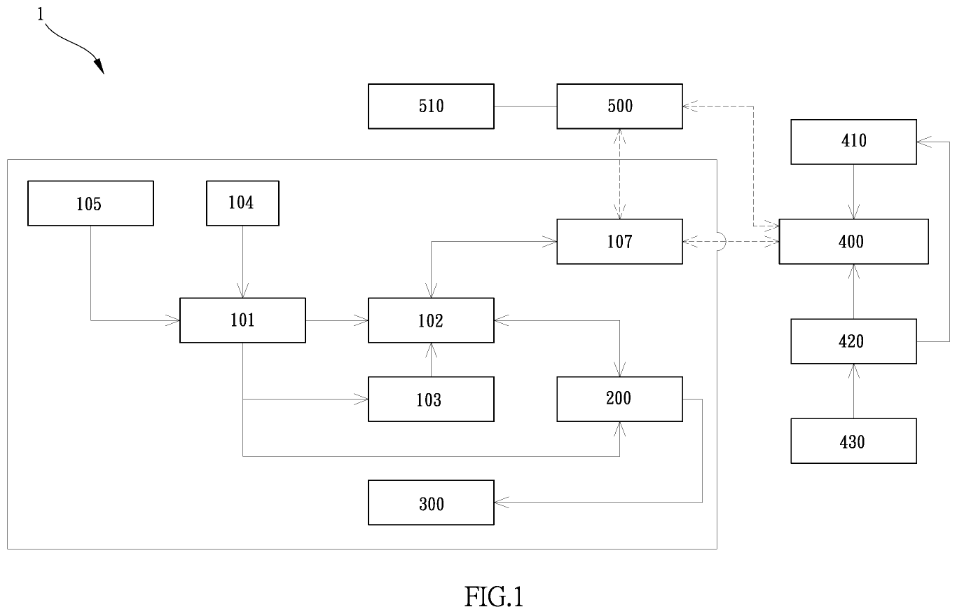

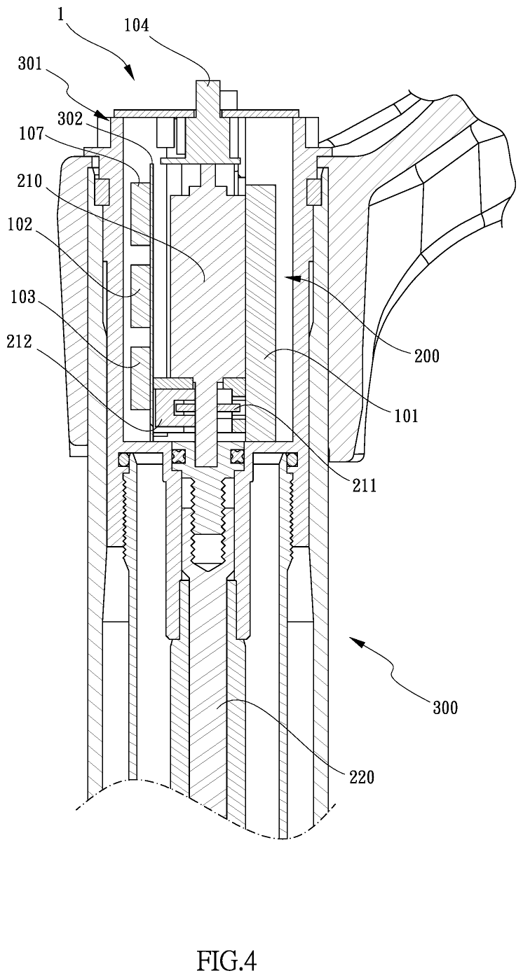

Referring to FIG. 1 to FIG. 4, a bicycle automatic shock absorbing device 1 is provided. The bicycle automatic shock absorbing device 1 includes a shock absorbing battery 101, a control chip 102, a sensor 103, and a driving module 200 installed in a shock absorber 300; wherein the shock absorbing battery 101 is electrically connected to the control chip 102, the sensor 103 and the driving module 200 correspondingly; wherein the control chip 102 is signally connected to the sensor 103 and the driving module 200 correspondingly. Further, when the control chip 102 operates an automatic shock absorbing mode M101, the sensor 103 detects the shock impact and transmits a detection signal (acceleration value) to the control chip 102, and the control chip 102 transmits an adjustment signal to the driving module 200, so that the driving module 200 changes the damping response of the shock absorber 300.

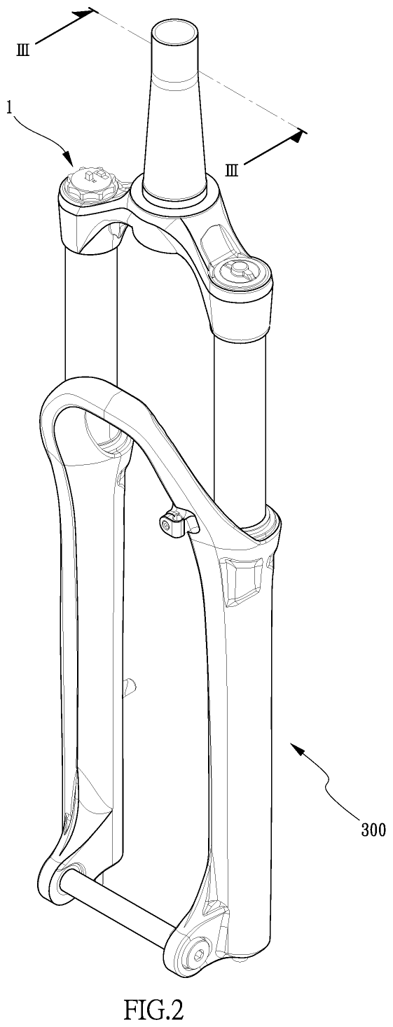

The above-mentioned sensor 103 is an accelerometer, also known as an acceleration sensor, and a gravitational acceleration sensor. In one embodiment, the shock absorbing battery 101, the control chip 102, and the sensor 103 are mounted on a cover 301 of the inner side of the shock absorber 300 (the left position in FIG. 2), and the cover 301 is equipped with a circuit board 302 for fixing the control chip 102 and the sensor 103, and is electrically connected to the shock absorbing battery 101 and the sensor 103 through the circuit board 302.

When the bicycle automatic shock absorbing device 1 of the present disclosure operates, the control chip 102 executes the automatic shock absorbing mode M101, the shock impact during riding is detected through sensor 103 and transmitted detection signals to the control chip 102, and the control chip 102 transmits the adjustment signal to the driving module 200, so that the driving module 200 changes the damping response of the shock absorber 300 instantly. Therefore, the change in acceleration can be detected by the sensor 103 while riding, and the control chip 102 determines the shock acceleration value during the riding process and transmits the control signal to the driving module 200 to change the damping effect of the shock absorber 300 and meet the road conditions.

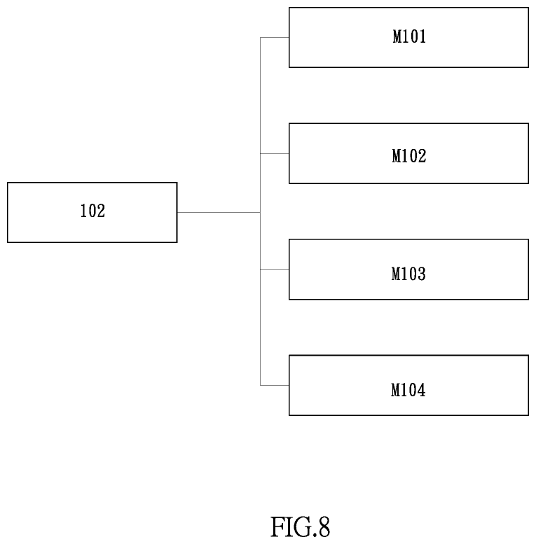

Regarding the bicycle automatic shock absorbing device 1 of the present disclosure, the control chip 102 saves a soft shock absorbing mode M102, a balanced shock absorbing mode M103, a hard shock absorbing mode M104 and the automatic shock absorbing mode M101, as shown in FIG. 8.

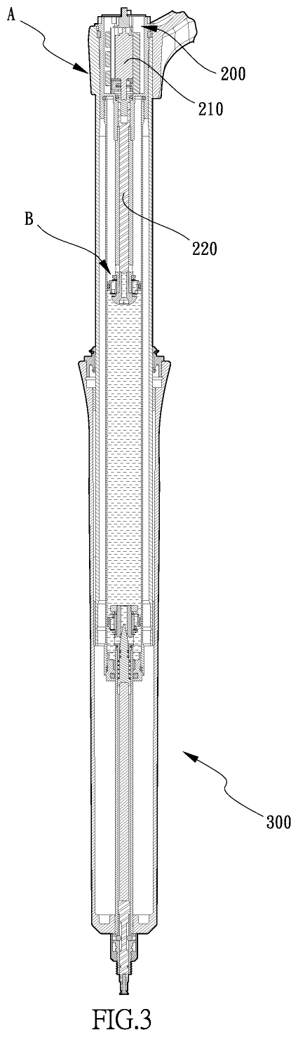

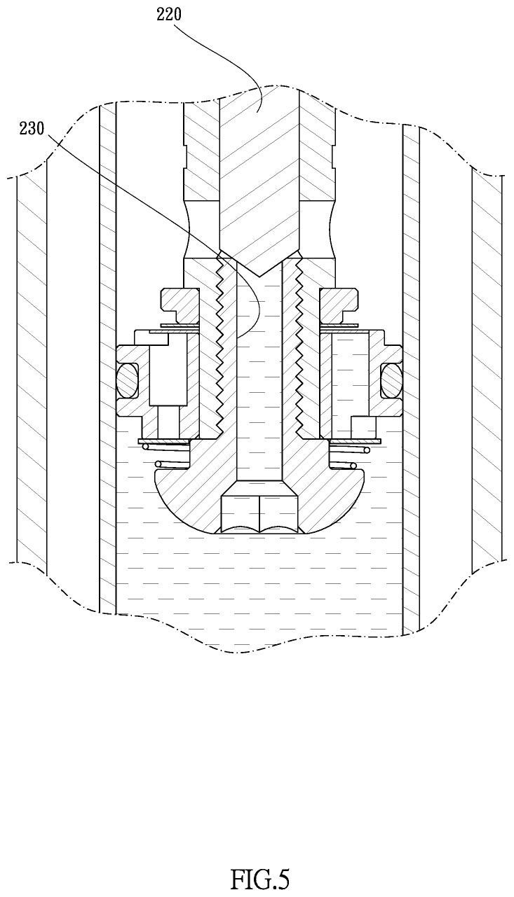

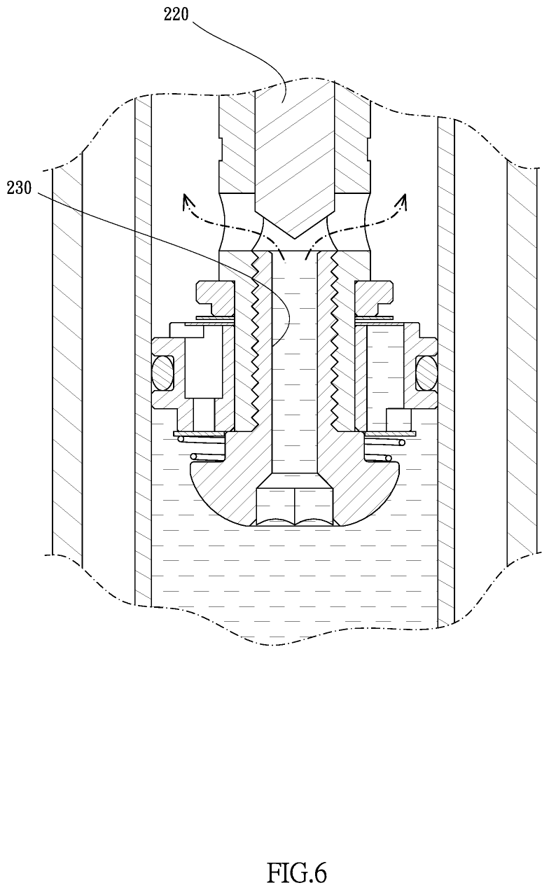

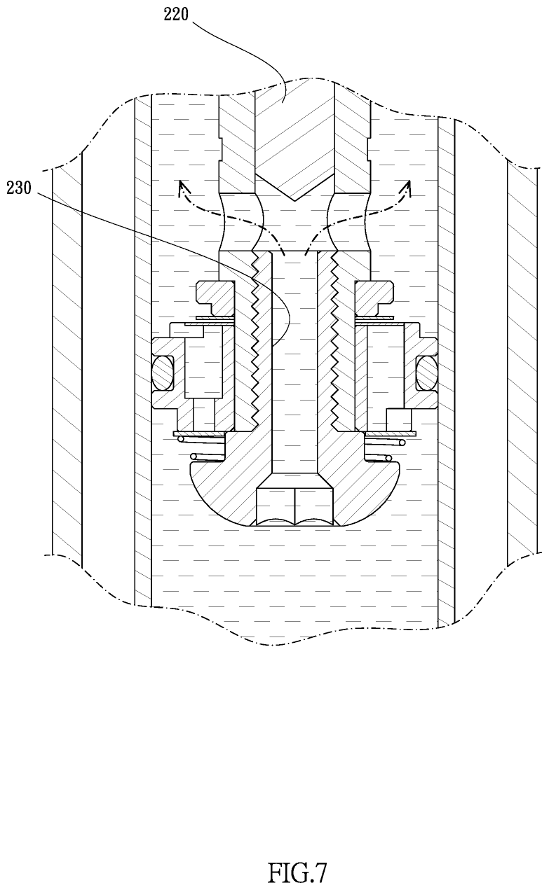

Regarding the damping effect of the shock absorber 300, which is to be read in conjunction with FIGS. 3-7, the motor 210 of the driving module 200 operates and indirectly drives the valve stem 220 to move along the axial direction of the front fork, so that the end of the valve stem 220 changes in locations such as closing the flow channel 230, near the flow channel 230, and away from the flow channel 230. The location of the end of the valve stem 220 leads to block fluid flow, restrict fluid flow(blocked by the end of the valve stem 220), and smooth fluid flow (unblocked by the end of the stem 220), which form the front fork lock state (corresponding to the hard shock absorbing mode M104), the front fork relaxation state (corresponding to the balanced shock absorbing mode M103), and the unlocking state (corresponding to the soft shock absorbing mode M102) respectively. The move distance of the valve stem 220 can be driven by the motor 210 when the vane 211 rotates, and the photo-interrupter 212 senses the number of revolutions of the vane 211 to convert the move distance of the valve stem 220 to close the flow channel 230, near the flow channel 230, or away from the flow channel 230, thereby forming the compression damping effect of the shock absorber 300.

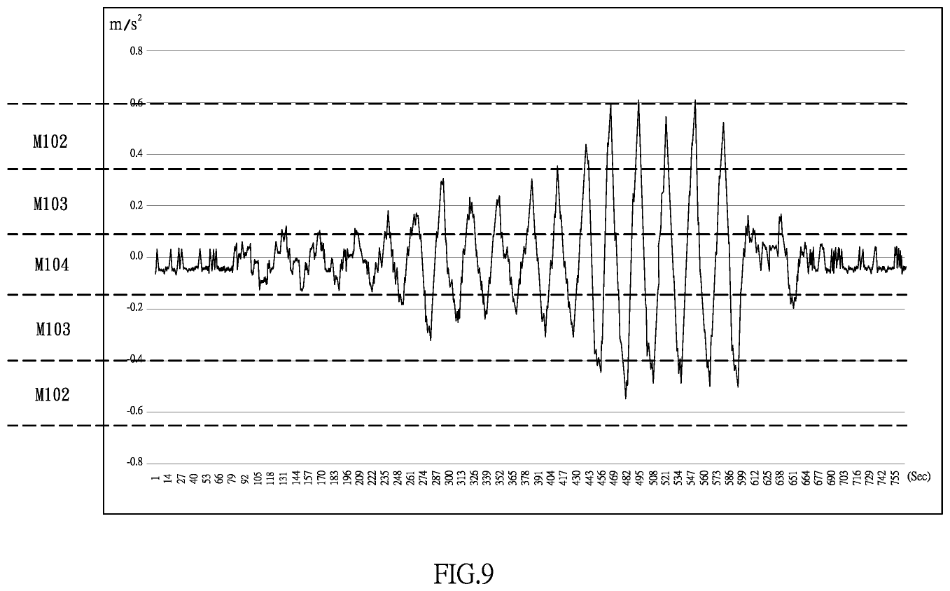

Referring to FIG. 9, which is the automatic shock absorbing mode of the present disclosure, the left longitudinal axis is the acceleration (m/s²), and the lower lateral axis is the elapsed time (sec). Further, FIG. 9 shows five lateral sections, and the middle section shows the acceleration from 0.1 m/s² to −0.18 m/s², the damping effect of the shock absorber 300 is adjusted to the hard shock absorbing mode M104. Furthermore, the sections between the middle section and the outer sections show the accelerations from −1.8 m/s² to −0.4 m/s² and from 0.18m/s² to 0.38 m/s², the damping effect of the shock absorber 300 is adjusted to the balanced shock absorbing mode M103. The outer sections show the acceleration from −0.4 m/s² to −0.62 m/s² and from 0.38 m/s² to −0.6 m/s², the damping effect of the shock absorber 300 is adjusted to the soft shock absorbing mode M102.

The bicycle automatic shock absorbing device 1 of the present disclosure further includes a switch 104 being electrically connected to the shock absorbing battery 101 for controlling the output and not output of the shock absorbing battery 101 to the control chip 102, sensor 103 and the driving module 200. In order to facilitate the user to switch between the activation and deactivation of the mode of the present disclosure, the switch 104 can be manually operated directly (herein, the switch 104 is a push button switch as an example) to turn the automatic shock absorbing mode on and off.

The bicycle automatic shock absorbing device 1 of the present disclosure further includes a charging port 105 being electrically connected to the shock absorbing battery 101. When the connector that provides the external power supply is plugged in the charging port 105, the shock-absorbing battery 101 is charged. The charging port 105 here is in the form of a USB connector as an example. The above-mentioned charging port 105 is partially fixed to the circuit board 302 and passes through the top position of the cover 301 and is partially exposed. In addition, a cap 106 can be put on the charging port 105 to prevent dust, sundries and water from entering the charging port 105 that affect charging.

The bicycle automatic shock absorbing device 1 further includes a

Bluetooth antenna 107 electrically connected to the control chip 102; wherein, a fixed controller 400 is connected to the control chip 102 by a duplex wireless signal via the Bluetooth antenna 107; wherein, the fixed controller 400 includes an operation button 410. The fixed controller 400 can be mounted and positioned on the bicycle (handlebar, for example) by the torsion ring to facilitate the user to operate the fixed controller while riding. Further, by pressing the operation button 410, a fixed control signal is transmitted through the Bluetooth antenna 107 to the control chip 102 for executing the soft shock absorbing mode M102, the balanced shock absorbing mode M103, the hard shock absorbing mode M104 or the automatic shock absorbing mode M101, so that the driving module 200 changes the damping response of the shock absorber 300.

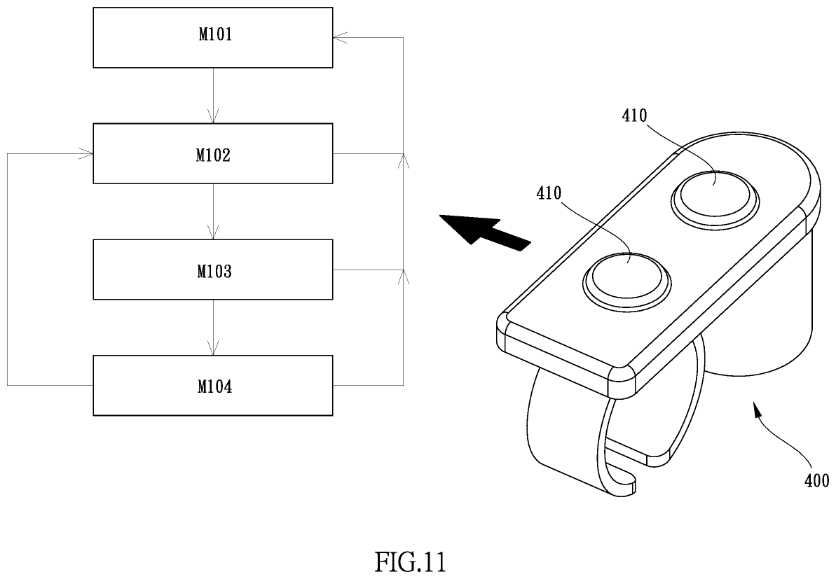

Regarding the operation of the fixed controller 400, the soft shock absorbing mode M102, the balanced shock absorbing mode M103, and the hard shock absorbing mode M104 are switched with each press. A long press switches the automatic shock absorbing mode M101, and another long press can cancel the automatic shock absorbing mode M101, as shown in FIG. 11. Through the fixed controller 400, it is convenient for the user to adjust to the automatic shock absorbing mode M101 under manual operation, or manually switch to soft shock absorbing mode M102, the balanced shock absorbing mode M103 or the hard shock absorbing mode M104. Accordingly, it provides the user with other choices to simply and quickly adjust the damping effect of the shock absorber 300 except to the automatic shock absorbing mode M101. Especially for appropriate self-control when applied to known road conditions, such as paved roads, mixed sand roads, or bumpy trails.

In addition, the fixed controller 400 includes a control battery 420 and a charging plug 430, and the shock absorbing battery 101 is electrically connected to the operation button 410 and the charging plug 430 correspondingly. The control battery 420 is charged by a connector provided with the external power source through the charging plug 430. The above-mentioned charging plug 430 may be a USB plug.

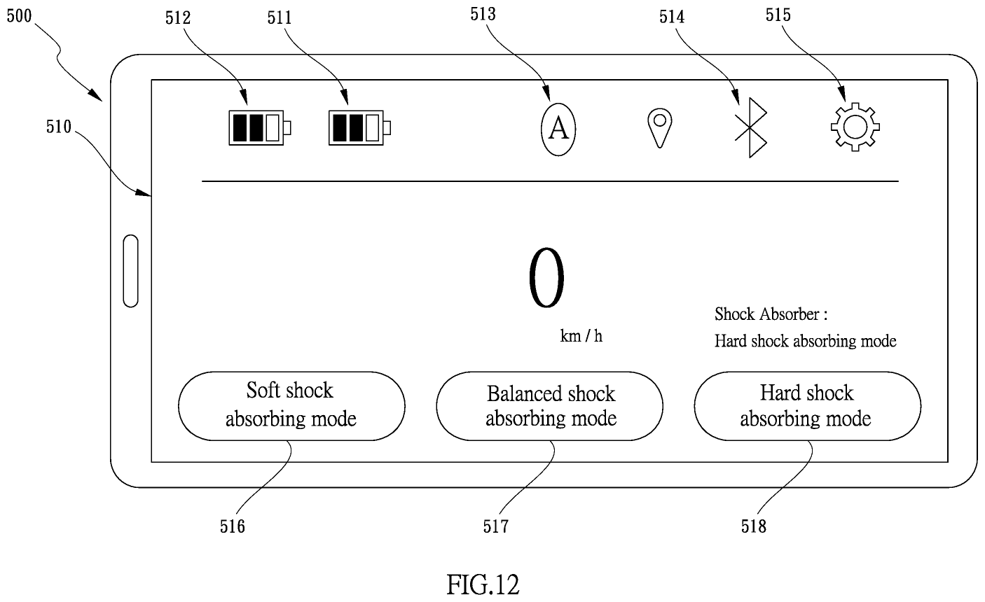

The bicycle automatic shock absorbing device 1 further includes a portable device 500 duplex wireless signal connected to the control chip 102 via the Bluetooth antenna 107, and the portable device 500 being connected to the fixed controller 400 via the Bluetooth signal. The portable device 500 includes an operation interface 510, and the operation interface 510 includes a shock absorbing battery power status bar 511, a control battery power status bar 512, an automatic shock absorbing mode icon 513, a Bluetooth icon 514, a setting icon 515, a soft shock absorbing mode icon 516, balanced shock absorbing mode icon 517, hard shock absorbing mode icon 518, as shown in FIG. 12.

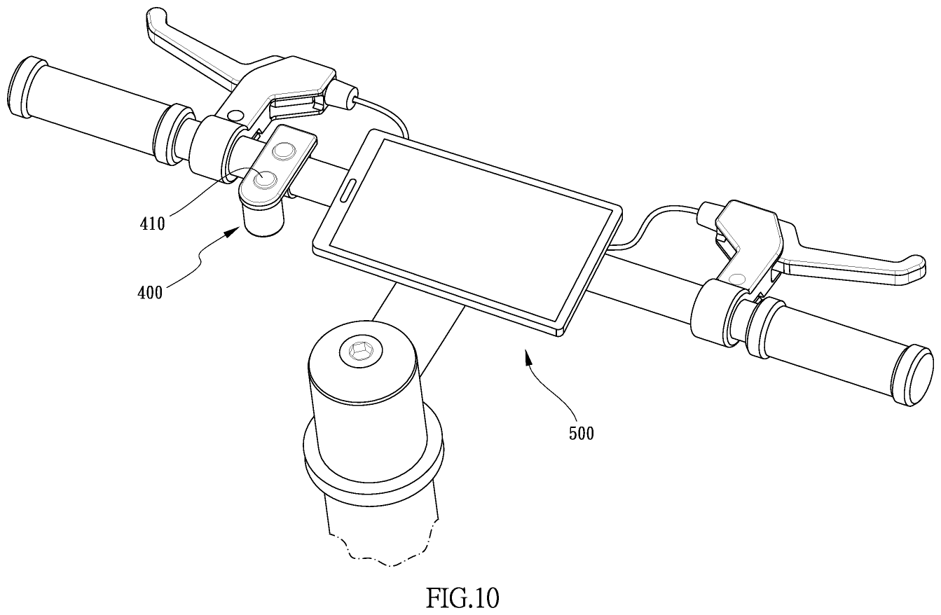

The above-mentioned portable device 500 can be a mobile device, such as a smartphone or a tablet, and the operation interface 510 is a software program such as APP (Application) downloaded by the portable device 500 through the Internet and installed on the portable device 500 and can be executed. The above-mentioned portable device 500 is mounted on the handlebar or the stem position by a bracket. In one embodiment, the portable device 500 is located above the stem, as shown in FIG. 10. The portable device 500 provides the user with another option to operate the device, and the operation interface 510 includes the automatic shock absorbing mode icon 513, the soft shock absorbing mode icon 516, the balanced shock absorbing mode icon 517, the hard shock absorbing mode icon 518 for manually selecting the appropriate damping effect of the shock absorber. The shock absorbing battery power status bar 511 and the control battery power status bar 512 can show the current power of both the shock absorbing battery 101 and the control battery 420. The Bluetooth icon 514 provides on and off operation of the Bluetooth communication of the portable device 500, that is, the duplex Bluetooth communication is provided between the portable device 500 and the fixed controller 400 and the bicycle automatic shock absorbing device. The above-mentioned setting icon 515 can be operated to change the connection password between the portable device 500 and the bicycle automatic shock absorbing device of the present disclosure.

What is claimed is:

1. A bicycle automatic shock absorbing device, comprising a shock absorbing battery, a control chip, a sensor, and a driving module installed in a shock absorber;
wherein, the shock absorbing battery is electrically connected to the control chip, the sensor and the driving module correspondingly;
wherein, the control chip signally connected to the sensor and the driving module correspondingly;
wherein, when the control chip operates an automatic shock absorbing mode, the sensor detects the shock impact and transmits a detection signal to the control chip, and the control chip transmits an adjustment signal to the driving module, so that the driving module changes the damping response of the shock absorber.

2. The bicycle automatic shock absorbing device according to claim 1, wherein the control chip saves a soft shock absorbing mode, a balanced shock absorbing mode, a hard shock absorbing mode and the automatic shock absorbing mode.

3. The bicycle automatic shock absorbing device according to claim 1, further including a switch being electrically connected to the shock absorbing battery.

4. The bicycle automatic shock absorbing device according to claim 1, further including a charging port being electrically connected to the shock absorbing battery.

5. The bicycle automatic shock absorbing device according to claim 1, further including a Bluetooth antenna electrically connected to the control chip; wherein, a fixed controller is connected to the control chip by a duplex wireless signal via the Bluetooth antenna; wherein, the fixed controller includes an operation button.

6. The bicycle automatic shock absorbing device according to claim 5, wherein the fixed controller includes a control battery and a charging plug, and the shock absorbing battery is electrically connected to the operation button and the charging plug correspondingly.

7. The bicycle automatic shock absorbing device according to claim 5, further including a portable device duplex wireless signal connected to the control chip via the Bluetooth antenna, and the portable device being connected to the fixed controller via the Bluetooth signal.

8. The bicycle automatic shock absorbing device according to claim 6, wherein the portable device includes an operation interface, and the operation interface includes a shock absorbing battery power status bar, a control battery power status bar, an automatic shock absorbing mode icon, a Bluetooth icon, a setting icon, a soft shock absorbing mode icon, a balanced shock absorbing mode icon, and a hard shock absorbing mode icon.
